(19) United States
(12) Patent Application Publication
(10) Pub. No.: US 2016/0369774 A1
(43) Pub. Date: Dec. 22, 2016

(54) WIND TURNBINE

(71) Applicant: NABRAWIND SL, Pamplona (ES)

(72) Inventors: Eneko SANZ PASCUAL, Pamplona (ES); Hely Ricardo SAVII COSTA, Uterga (ES)

(21) Appl. No.: 15/254,661

(22) Filed: Sep. 1, 2016

Related U.S. Application Data
(63) Continuation of application No. PCT/ES2014/000037, filed on Mar. 4, 2014.

(51) Int. Cl. F03D 7/02; F03D 9/25; F03D 80/80; F03D 9/00; F03D 15/00; F03D 80/70

(52) U.S. Cl. CPC F03D 7/0204; F03D 15/00; F03D 80/70; F03D 80/88; F03D 9/002; F03D 9/25

(57) ABSTRACT

According to one embodiment a wind turbine drive train with a nacelle in a tower with a big diameter which allows embedding the generator inside and reducing the loads in the support connectors of the rotation system and in the tower. The mainframe of the nacelle has a triangular shape based on structural frames or ribs, taking profit of the big reaction arm with a compact solution. The generator is integrated in this mainframe. The rotation system is made by individual supports on a continuous rotating ring and the traction elements provokes the rotation of the nacelle around the tower without the need of the usual geared pinion-zip systems, using pneumatic wheels which roll by the raceway made by the rotation ring with inverted T shape with one or two circular sections on the top of its profile.

### CROSS-REFERENCE TO RELATED APPLICATIONS

This application relates to and claims the benefit and priority to International Application No. PCT/2014/000037, filed Mar. 4, 2014.

### TECHNICAL FIELD

The present invention is comprised in the field of wind turbines, and more specifically, in the field of a wind turbine having a drive train that is directly coupled to a generator arranged inside the nacelle and attached through its corresponding transmission system to the wind rotor arranged outside the nacelle.

### BACKGROUND

Drive trains without a step-up gear, i.e. those having the generator coupled directly to the rotor, are well known today. M Torres and Jeumount designs are added to ENERCON E-30, E-40, etc. machines. Currently, Siemens, Areva, Alstom, Vestas, Ming Yang, Goldwin or IMPSA are developing configurations of this type. It can therefore be concluded that the configuration of a generator coupled directly to the rotor, also including a generator frequency converter for decoupling said generator from the grid, is well known in the prior art.

The function of the mainframe of a nacelle is in any case to support the drive train and to transmit loads not derived from the rotor torque to the tower through the rotation ring. Most manufacturers follow the same fundamental principles in designing said mainframe, with ductile cast steel being the most widespread today.

To understand the different mainframes it is necessary to analyze different drive train configurations including specific features such as in patent document ES 2277795 A1, belonging to Gamesa, where the rotor and generator are arranged on both sides of the tower. The main shaft is coupled to the hub and the rotor of the generator, and the mentioned shaft is furthermore supported between bearings arranged on both sides of the tower.

Patent document US 20050230979 A1, belonging to Northern Power Systems, discloses a directly coupled generator and a rotor, both being located on the same side of the tower. Furthermore, the brake is integrated in the generator stator and the transformer is below the nacelle, inside the tower.

In fact, in 2005, NREL together with Northern Power Systems, in the “WindPACT Drive Train Alternative Design Study Report”, analyzed several drive train configurations according to the position of the generator with respect to the tower and the rotation ring, and with respect to the resulting frame solution. Nevertheless, in all of them the tower and therefore rotation ring diameter is reduced and limits the advantages of embedding the generator in the rotation ring itself.

Finally, the patent document US 2009250939 A1, belonging to TianDi Growth Capital, discloses a drive train on a 5 to 10 meter platform which at the same time is the rotation system of the nacelle and the mainframe itself. The rotor feeds at least 9 generators. The bearings are separated from one another by 10 meters, and in between the rotating shaft there are different sets of pinion gears moving the generators. According to its claim 1, the drive train is characterized in that the generators moving the main shaft rotate below the line of the rotation system.

Of all these configurations, the latter can be considered the closest prior art. However, there are many problems with this configuration: the huge main shaft dimensions with respect to the two sole rolling supports existing in the narrow ring supporting it, the considerable weight of the multiple generator (it feeds at least 9 generators) and therefore the resulting frame complexity to prevent excessive bending of the bi-supported main shaft and to house both the central wheel and all subsequent generators.

The drive trains disclosed and contemplated herein solve this and other problems derived from the direct connection between the main shaft and the generator without intermediate gears. The type of structure of the mainframe of the drive train, based on ribs compared with complex cast pieces, simplifies both the design and the manufacture thereof and allows making it modular to reduce transport costs, furthermore taking advantage of the large reaction arm of a large diameter rotation ring. It furthermore allows efficiently solving the position of the generator inside the rotation ring, reducing the height of the main shaft with respect to said ring, and therefore reducing the loads thereof.

In regard to the yaw system, all manufacturers use continuous bearings (roller bearings or slide bearing), with a driving system based on gears and electric motors. However, the patent document US 2009250939 A1 proposes a continuous rolling raceway but discrete supports, like those disclosed herein. The main difference between them is the design of both the rolling raceway and of said discrete supports, which are aimed at supporting associated loads in multiple directions.

### SUMMARY OF THE DISCLOSURE

According to one aspect, providing a compact drive train and nacelle configuration for a large diameter tower is desired, taking into account aspects relating to component accessibility and maintenance. With current sizes of multi-megawatt wind turbines, arranging the transmission system at the top of the tower conditions the structural design of the support of the drive train.

According to another aspect, providing the rotor with an attachment to a mainframe or fixed support which is attached through the yaw system to a connection system formed by a connection piece connected to the tower is desired. Said mainframe has a hollow shaft anchored at one of its ends where the main bearing supporting the rotor is arranged and from where the main shaft extends.

According to another aspect, the main shaft is supported on the aforementioned support which also holds the generator and brake. According to one implementation the mainframe is triangular with the main shaft, generator and brake contained therein. The supports of the generator are part of the mainframe that are constructed with ribs having flanges and webs, and include the respective bearings, one on each side of the set forming the generator and the brake.

According to another aspect, the generator that is supported on the mainframe partially passes through the connection piece itself arranged on the tower.

According to another aspect the drive train includes a yaw system with a set of rolling members sliding on a ring arranged on an annular connection piece supported on the tower. Drive members activating rotation of the nacelle about the tower without requiring the usual rack and pinion gearing is also provided. The motors used by the drive members are electric motors, and they activate a series of pneumatic wheels rolling on the rolling raceway formed by the rotation ring. In the case of downwind turbines, where the yaw system can be passive and may not require a driving system, the drive members could be eliminated and only the rolling members allowing rotation and transmitting loads would remain.

The following advantages can be deduced from the foregoing:

A large diameter rotation ring is associated with the advantage of greatly reducing vertical loads resulting in the discrete supports thereof. In regard to the mainframe, the distance between supports and therefore the bending loads are also increased. As a result, the triangular configuration of the mainframe takes advantage of the reaction arm and minimizes loads on the supports, in a most compact way possible. In addition, the proposed mainframe based on ribs provides the necessary flexural rigidity to the structure in an efficient manner. To that end, these ribs are formed by a flange and a web with windows or relief members. This structure furthermore allows making the design modular for the purpose of reducing transport costs and of suitably housing all the members of the drive train: bearings, brake and generator.

Additionally, the proposed structure allows embedding the generator in the central opening of the rotation ring and of the connection piece, and therefore reducing the distance between the shaft of the rotor and the rotating plane of the rotation ring (yaw), with a subsequent load reduction.

Finally, the design of the rolling raceway and supports of the yaw system allows drastically reducing the number of rolling members, therefore reducing the cost of the assembly.

### BREIF DESCRIPTION OF THE DRAWINGS

A set of drawings which help to better understand the invention is provided. The drawings are expressly related to an embodiment of said invention and are presented as a non-limiting example thereof.

FIG. 1 is a general view of a wind turbine according to one implementation.

FIG. 2 shows in detail of part of the rotor, drive train connection piece and lattice tower according to one implementation.

FIG. 3 is a partial side view of the apparatus of FIG. 2 with some of the parts being sectioned.

FIG. 4 is a perspective view of the mainframe or fixed support with the hollow shaft according to one implementation.

FIG. 5A shows an attachment of the mainframe and connection piece through the yaw system according to one implementation.

FIG. 5B is a detailed illustration of a yaw system according to one implementation.

FIG. 6 shows a yaw system according to another implementation.

FIGS. 7 illustrates variants a, b, and c of driving systems according to some implementations.

### DETAILED DESCRIPTION

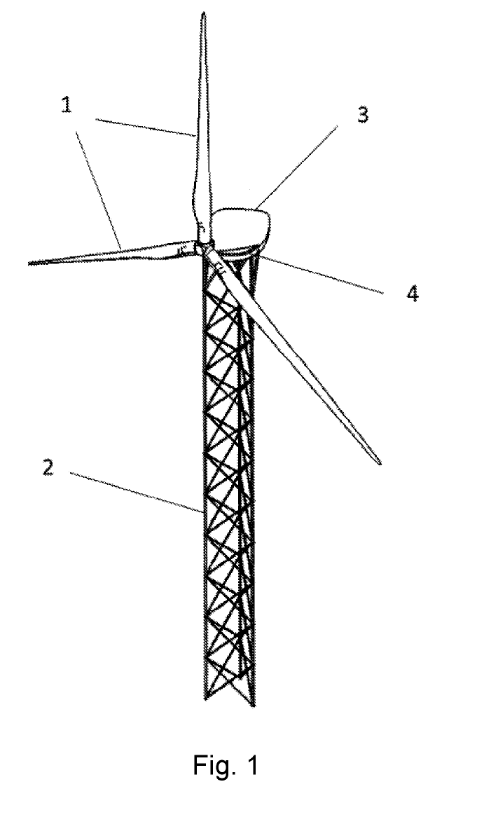

The wind turbine shown in FIG. 1 is a horizontal shaft wind turbine with three blades 1 facing downwind. The wind turbine includes a lattice tower having three legs of which are equally spaced from one another along the entire length thereof. The connection piece 4 is arranged between the nacelle 3 and the tower 2, and the drive train is arranged on said connection piece 4.

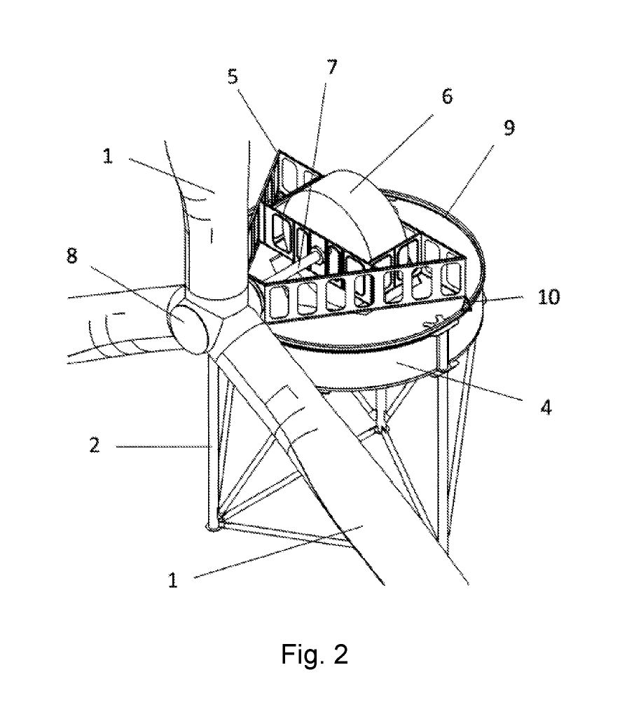

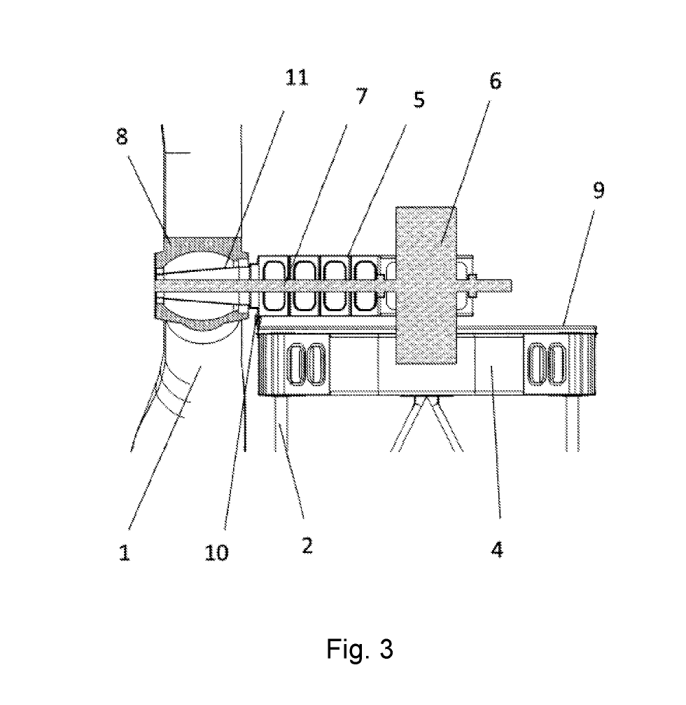

As shown in FIGS. 2 and 3, the lattice tower 2 supports the connection piece 4. A triangular mainframe 5 located above the connection piece internally houses the generator 6 and the main shaft 7 and also supports the rotor 8 at one of its ends. A rolling ring or raceway 9 that is part of the yaw system is arranged on the top of the connection piece 4. Said rotation system is made up of the mentioned ring 9 and the three supports 10, each one of said supports 10 being arranged in each vertex of the triangle forming the mainframe 5. The main shaft 7 passes through one of the vertexes of the mainframe 5 in the location of where a hollow shaft 11 having a main bearing is anchored. This arrangement makes it easier to rotate the rotor 8.

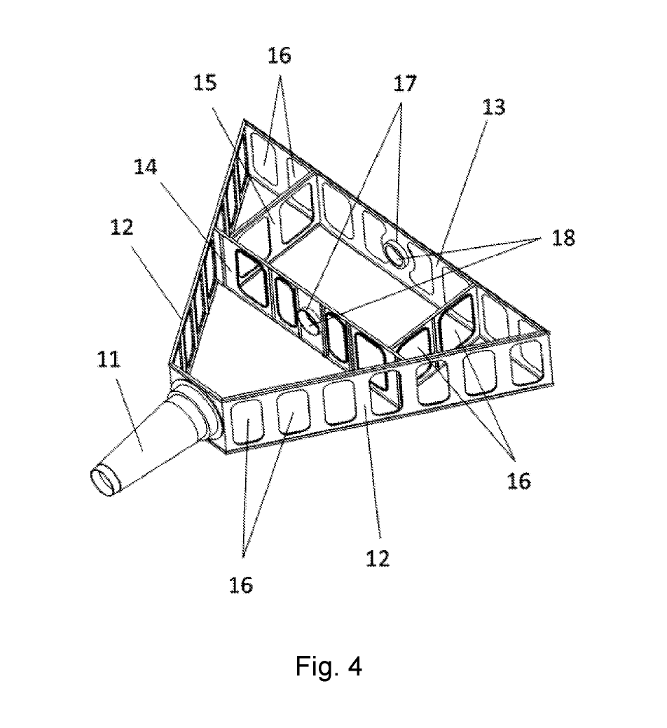

In FIG. 4, the triangular mainframe 5 is formed with outer ribs and inner ribs. The outer ribs are made up of side ribs 12 and the bottom rib 13. The inner ribs in turn are made up of the support rib 14 and the reinforcement rib 15, both defining the opening where the generator will be housed. In the embodiment shown, all the ribs have relief windows 16 distributed uniformly about the entire surface. The supports 17 of the generator 6 are integrated into the ribs of the mainframe 5 and include respective bearings 18, one on each side of the set forming the generator and brake (not shown in the drawing).

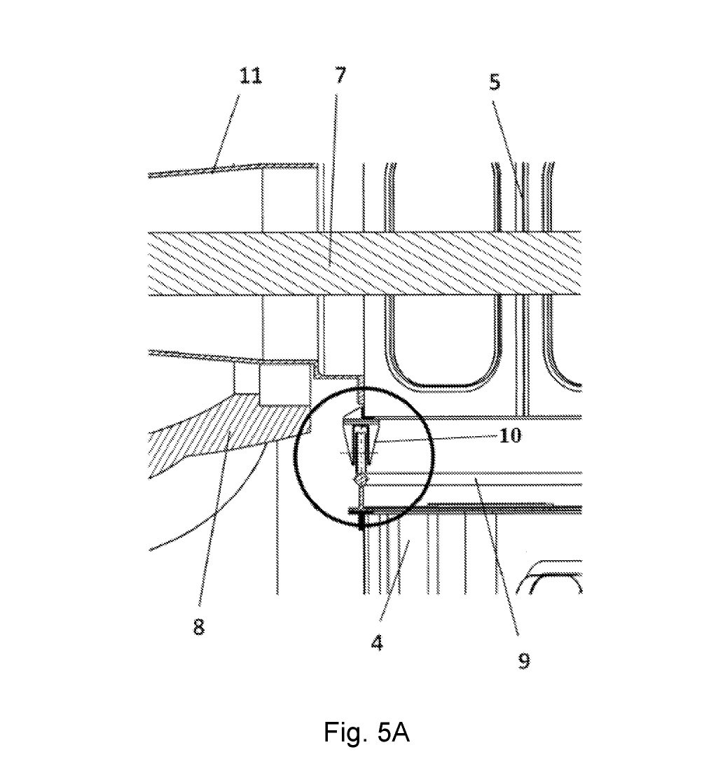

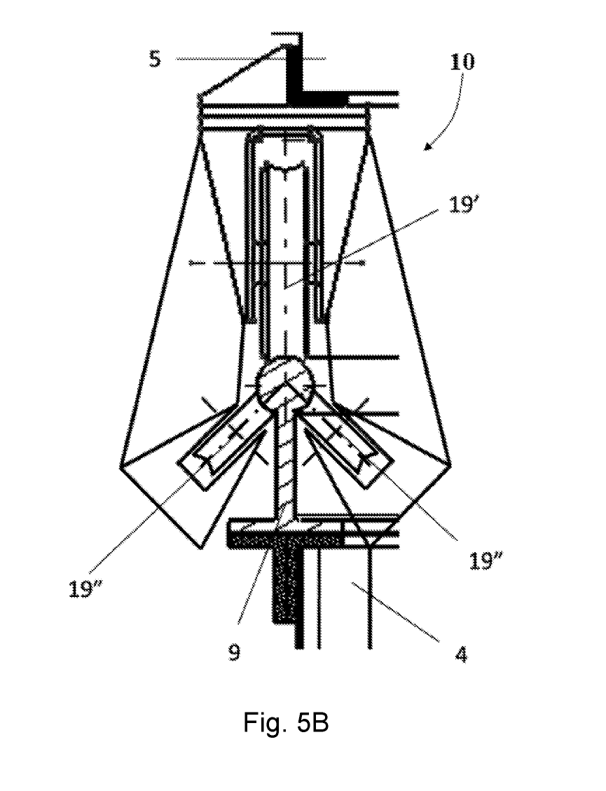

As shown in FIGS. 5A and 5B, the mainframe 5 is supported on the connection piece 4 through the rolling system made up of a rolling ring 9 and the corresponding supports 10. According to one embodiment the rolling ring 9 has an inverted T shape at the base and a circular shape in the top. The enlarged detail of FIG. 5B shows a connector 10 having three rolling members 19 that roll on the rolling ring 9. According to one embodiment said rolling members are spaced 120° from one another and are arranged to support horizontal and vertical loads produced by the rotation of the wind turbine on the tower.

The upper rolling member 19′ transmits vertical compressive loads to the tower. The two inclined rolling members 19″ can support both vertical and horizontal tensile loads due to their angular orientation.

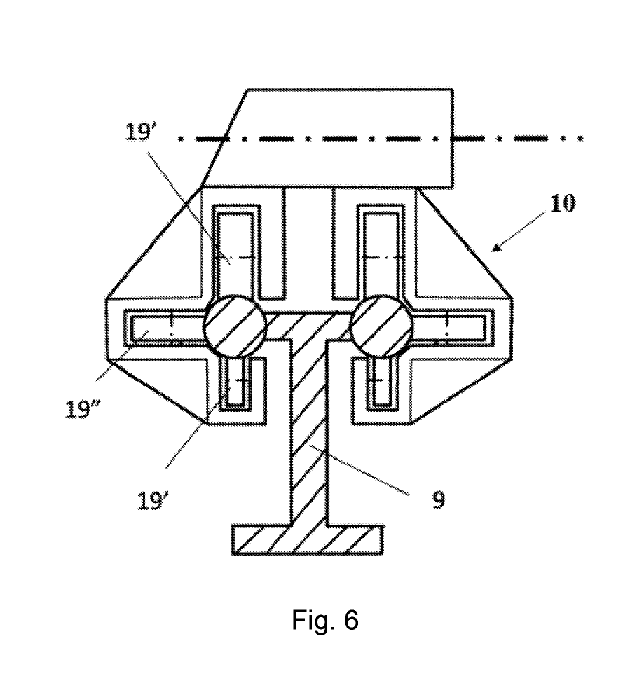

FIG. 6 is another embodiment where the rolling ring 9 is double T-shaped and the top is complemented with two circular shapes and three rolling members 19 in each flange of the T, arranged symmetrically with respect to the ring 9 and separated 90° from one another. This arrangement means that the vertical rolling members 19′ transmit only vertical loads and the horizontal members 19″ transmit only horizontal loads.

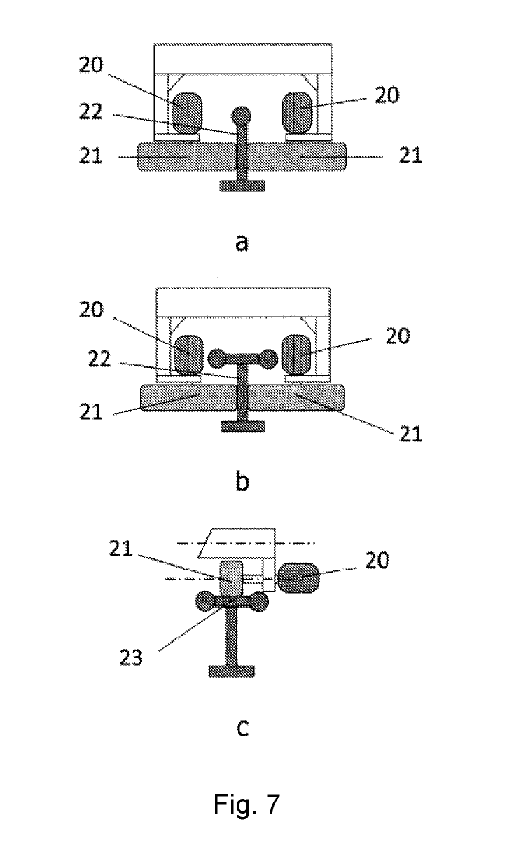

FIG. 7 shows driving systems of the rolling members according to if one rolling ring 9 or another is selected. In this case, the yaw system does not support loads but rather causes rotation driven by the drive members, preferably electric motors 20, located above the wheels 21. Said pneumatic wheels drive in the central part 22 of the rolling ring 9, as shown in embodiments a and b, or the wheels 21 drive in the top 23 of the rolling ring 9, as shown in embodiment c. The driving systems are part of the rolling system made up of the supports 10.

What is claimed is:

1. A wind turbine comprising:
a plurality of blades connected to a rotor,
a generator having a first side, a second side, an upper part and a lower part, the generator being coupled directly to the rotor by a main shaft that extends from the first and second sides,
a mainframe having a triangular shape that is formed by a group of ribs, the mainframe having a first, second and third vertex, the group of ribs including a first side rib, a second side rib, a bottom rib and a support rib, the support rib being located between the bottom rib and the first vertex, the support rib having a first support that supports a first portion of the main shaft located on the first side of the generator, the bottom rib comprising a second support that supports a second portion of the main shaft located on the second side of the generator,
a hollow shaft in which a third portion of the main shaft is supported, the hollow shaft being coupled to the first vertex of the mainframe,
a connection piece configured to be attached to a top of a tower,
a rotation ring having a lower end and an upper end, the lower end being attached to the connection piece, the mainframe being rotationally coupled to the upper end of the rotation ring by a first support connector that is coupled to one of the first, second and third vertices and a second support connector that is coupled to one of the first, second and third vertices that is not coupled to the first support connector,
the generator being arranged such that the lower part passes through both the rotation ring and the connection piece.

2. The wind turbine according to claim 1, wherein each of the first and second supports includes bearings coupled to the main shaft.

3. The wind turbine according to claim 1, wherein each of the first side rib, second side rib, bottom rib and support rib include relief windows.

4. The wind turbine according to claim 1, further comprising first and second spaced-apart reinforcement ribs that extend between the support rib and the bottom rib, the generator being located inside an enclosure formed by the support rib, bottom rib, first reinforcement rib and second reinforcement rib.

5. The wind turbine according to claim 1, further comprising a third support connector, the first, second and third support connectors being attached to the mainframe at the first, second and third vertices, respectively

6. The wind turbine according to claim 1, wherein the upper end of the rotation ring comprises a first protuberance having a peripheral surface, the peripheral surface comprising a first section, a second section and third section that are each spaced apart from one another, at least one of the first and second support connectors comprising first, second and third rolling members that rotate about first, second and third rotational axes, respectively, each of the first, second and third rolling members having an outer radial surface, the outer radial surfaces of the first, second and third rolling members being positioned to respectively roll against the first, second and third sections of the peripheral surface of the first protuberance to permit the mainframe to rotate on the rotation ring.

7. The wind turbine according to claim 6, wherein the first protuberance of the rotating ring has an at least partially annular shape.

8. The wind turbine according to claim 6, wherein at least one of the first, second and third rolling members is coupled to a drive member that is configured to rotate the at least one of the first, second and third rolling members.

9. The wind turbine according to claim 6, wherein the angular orientation of the first, second and third rotational axes are different from one another.

10. The wind turbine according to claim 6, wherein the angular orientation of the first and second rotational axes are the same and the third rotational axis is orthogonal to the first and second rotational axes.

11. The wind turbine according to claim 9, wherein the first, second and third rolling members are oriented 120 degrees apart from one another.

12. The wind turbine according to claim 10, wherein the second rolling member is oriented 90 degrees apart from each of the first and third rolling members.

13. The wind turbine according to claim 1, wherein the rotation ring has an inverted T-shape.

14. The wind turbine according to claim 6, wherein the upper end of the rotation ring comprises a second protuberance spaced-apart from the first protuberance, the second protuberance having a peripheral surface comprising a first section, a second section and third section that are each spaced apart from one another, the support connector further comprising fourth, fifth and sixth rolling members that rotate about fourth, fifth and sixth rotational axes, respectively, each of the fourth, fifth and sixth rolling members having an outer radial surface, the outer radial surfaces of the fourth, fifth and sixth rolling members being positioned to respectively roll against the first, second and third sections of the peripheral surface of the second protuberance.

15. The wind turbine according to claim 14, wherein the second protuberance of the rotating ring has an at least partially annular shape.

16. The wind turbine according to claim 14, wherein at least one of the fourth, fifth and sixth rolling members is coupled to a drive member that is configured to rotate the at least one of the fourth, fifth and sixth rolling members.

17. The wind turbine according to claim 14, wherein the angular orientation of the fourth, fifth and sixth rotational axes are different from one another.

18. The wind turbine according to claim 14, wherein the angular orientation of the fourth and fifth rotational axes are the same and the sixth rotational axis is orthogonal to the fourth and fifth rotational axes.
